(19) United States
(12) Patent Application Publication
(10) Pub. No.: US 2026/0228348 A1
(43) Pub. Date: Aug. 6, 2026

(54) SYSTEM AND METHOD FOR TRACKING DESTRUCTION OF HARDWARE

(71) Applicant: Apto Solutions Inc., Atlanta, GA (US)

(72) Inventors: Jeffrey A. Jones, Atlanta, GA (US); Charles Farrow, Atlanta, GA (US); Joseph Ferguson, Atlanta, GA (US)

(21) Appl. No.: 19/454,719

(22) Filed: Jan. 21, 2026

Related U.S. Application Data
(60) Provisional application No. 63/754,250, filed on Feb. 5, 2025.

(51) Int. Cl. G06F 21/60; G06F 21/36; G06K 7/10; G06K 7/14

(52) U.S. Cl. CPC G06F 21/604; G06F 21/36; G06K 7/10722; G06K 7/1417

(57) ABSTRACT

A disposal system may include a shredder configured to destroy the electronic memory device and including an opening sized to receive the electronic memory device and a platform positioned adjacent to the opening. A camera is coupled to the shredder and defines a field of view at least as large as the opening, the camera is configured to capture image information associated with the electronic memory device and video information. A controller is configured to: receive the image information from the camera, process a unique identifier from the image information using object detection, authenticate the processed image information, receive the video information from the camera when the processed image information is authenticated; and save the processed image information, the video information, and the unique identifier for later recall.

### CROSS REFERENCE TO RELATED APPLICATIONS

This application claims the benefit of U.S. Provisional Patent Application No. 63/754,250 filed on Feb. 5, 2025, the entire contents of which are incorporated by reference herein.

### BACKGROUND

The present disclosure relates generally to information technology asset disposition (ITAD) and more particularly the present disclosure relates to disposal systems for electronic memory devices.

### SUMMARY

In some aspects, the disclosure relates to a disposal system for an electronic memory device, the disposal system including: a shredder configured to destroy the electronic memory device and including an opening sized to receive the electronic memory device and a platform positioned adjacent to the opening; a camera coupled to the shredder and defining a field of view at least as large as the opening, the camera configured to capture image information associated with the electronic memory device and video information; and one or more processing circuits including one or more memory devices coupled to one or more processors, the one or more memory devices configured to store instructions thereon that, when executed by the one or more processors, cause the one or more processors to: receive the image information from the camera; process a unique identifier from the image information using object detection; authenticate the processed image information; receive the video information from the camera when the processed image information is authenticated; and save the processed image information, the video information, and the unique identifier for later recall.

In some aspects, the disclosure relates to a disposal system, wherein the shredder includes a motor driving a cutter.

In some aspects, the disclosure relates to a disposal system, wherein the one or more memory devices are further configured to store instructions thereon that, when executed by the one or more processors, cause the one or more processors to inhibit operation of the motor if the processed image information is not authenticated. In some implementations, the one or more memory devices are further configured to store instructions thereon that, when executed by the one or more processors, cause the one or more processors to display an alert instead of or in addition to inhibiting operation of the motor if the processed image information is not authenticated.

In some aspects, the disclosure relates to a disposal system, wherein the one or more memory devices are further configured to store instructions thereon that, when executed by the one or more processors, cause the one or more processors to control operation of the camera to capture video information after the processed image information is authenticated.

In some aspects, the disclosure relates to a disposal system, wherein the one or more memory devices are further configured to store instructions thereon that, when executed by the one or more processors, cause the one or more processors to inhibit operation of the motor if the video information is not being captured.

In some aspects, the disclosure relates to a disposal system, wherein the one or more memory devices are further configured to store instructions thereon that, when executed by the one or more processors, cause the one or more processors to control operation of the camera to capture the image information when the electronic memory device is positioned on the platform.

In some aspects, the disclosure relates to a disposal system, wherein the camera is mounted to the shredder by a vibration damper.

In some aspects, the disclosure relates to a disposal system, wherein the vibration damper includes an arm and a magnetic base.

In some aspects, the disclosure relates to a disposal system, further including a light illuminating the field of view of the camera.

In some aspects, the disclosure relates to a disposal system, wherein the one or more memory devices are further configured to store instructions thereon that, when executed by the one or more processors, cause the one or more processors to: process the image information using a machine learning model to identify the unique identifier.

In some aspects, the disclosure relates to a disposal system, wherein the machine learning model is a you-only-look-once (YOLO) object detection model.

In some aspects, the disclosure relates to a disposal system, wherein the one or more memory devices are further configured to store instructions thereon that, when executed by the one or more processors, cause the one or more processors to: enhance the processed image information; and extract the unique identifier from the enhanced, processed image information.

In some aspects, the disclosure relates to a disposal system, wherein the one or more memory devices are further configured to store instructions thereon that, when executed by the one or more processors, cause the one or more processors to: validate the unique identifier against a pre-stored database and inhibit authentication if the unique identifier is not validated.

In some aspects, the disclosure relates to a disposal system, wherein the electronic memory device includes a quick response (QR) code® and the image information includes the QR code®, and wherein the one or more memory devices are further configured to store instructions thereon that, when executed by the one or more processors, cause the one or more processors to extract the unique identifier from the QR code®.

In some aspects, the disclosure relates to a disposal system, wherein the one or more memory devices are further configured to store instructions thereon that, when executed by the one or more processors, cause the one or more processors to: save the processed image information, the video information, and the unique identifier to a database; query the database in response to a user request; and generate a graphical user interface showing the processed image information, the video information, and the unique identifier in response to the query.

In some aspects, the disclosure relates to a system including: one or more processing circuits including one or more memory devices coupled to one or more processors, the one or more memory devices configured to store instructions thereon that, when executed by the one or more processors, cause the one or more processors to: receive image information from a camera via a receiving circuit; identify a quick response (QR) code® image within the image information using a machine learning model; enhance the QR code® image via an image enhancement circuit to generate an enhanced QR code® image; extract a unique identifier from the enhanced QR code® image via an extraction circuit; query a database with the unique identifier via an authentication circuit and return an authenticate code or a null code indicating no authentication; control the camera to record video information in response to receiving the authenticate code; control a motor of a shredder in response to receiving the authenticate code; and save the image information, the video information, and the unique identifier to the database.

In some aspects, the disclosure relates to a system, wherein the one or more memory devices are further configured to store instructions thereon that, when executed by the one or more processors, cause the one or more processors to: validate the unique identifier using expression-based pattern matching via a validation circuit before querying the database with the unique identifier via the authentication circuit.

In some aspects, the disclosure relates to a system, wherein the one or more memory devices are further configured to store instructions thereon that, when executed by the one or more processors, cause the one or more processors to: generate a graphical user interface for display on a user interface, wherein the graphical user interface prompts a user to capture the image information, confirms the authenticate code is generated, and prompt the user to capture the video information and operate the motor.

In some aspects, the disclosure relates to a system including: a shredder including an opening sized to receive an electronic memory device, a platform positioned adjacent the opening and sized to hold the electronic memory device, a motor, and a cutter driven by the motor; a camera positioned above the platform; and one or more processing circuits including one or more memory devices coupled to one or more processors, the one or more memory devices configured to store instructions thereon that, when executed by the one or more processors, cause the one or more processors to: receive image information from the camera via a receiving circuit; identify a visual identifier image within the image information via an object detection circuit; extract a unique identifier from the visual identifier image via an extraction circuit; authenticate the unique identifier via an authentication circuit; receive video information from the camera in response to authenticating the unique identifier; allow operation of the motor in response to authenticating the unique identifier; and save the image information, the video information, and the unique identifier to a database.

In some aspects, the disclosure relates to a system, wherein the one or more memory devices are further configured to store instructions thereon that, when executed by the one or more processors, cause the one or more processors to: generate a graphical user interface for display on a user interface, wherein the graphical user interface prompts a user to capture the image information, displays that the unique identifier is authenticated, and prompt the user to capture the video information and operate the motor.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a schematic diagram of a disposal system for electronic storage devices, according to some implementations.

FIG. 2 is a photo of a disposal system, according to some implementations.

FIG. 3 is a photo of the disposal system of FIG. 2, according to some implementations.

FIG. 4 is a right side photo of the disposal system of FIG. 2, according to some implementations.

FIG. 5 is a photo of a hard drive device, according to some implementations.

FIG. 6 is a photo of a base of a vibration damper of the disposal device of FIG. 2, according to some implementations.

FIG. 7 is a schematic representation of a controller of the disposal system of FIG. 1, according to some implementations.

FIG. 8 is a flowchart showing a method of disposing of a hard drive device, according to some implementations.

FIG. 9 is a schematic representation of an image capture method, according to some implementations.

FIG. 10 is a schematic representation of a hard drive verification method, according to some implementations.

FIGS. 11-14 are graphical user interfaces generated by the controller of FIG. 7, according to some implementations.

### DETAILED DESCRIPTION

Before turning to the figures, which illustrate the exemplary implementations in detail, it should be understood that the present application is not limited to the details or methodology set forth in the description or illustrated in the figures. It should also be understood that the terminology is for the purpose of description only. Like reference numerals in the figures may represent and refer to the same or similar element, feature, or function.

Hard drives contain sensitive information and in some industries it is important to have the ability to document chain of custody and proof of destruction. This disclosure is directed to a system for integrated destruction of memory devices including hard drives and a data storage system that correlates visual evidence of asset custody and physical destruction.

The systems and methods described herein create a verification procedure which allows a user the flexibility to provide proof of chain of custody for the destruction process of hard drives or other memory devices through a trained machine learning or artificial intelligence program, database, and information management system.

A camera, working in tandem with a computer application, captures a photo of the hard drive waiting to be dropped into the shredder, reads a QR code® with a unique Proprietary ID, and saves it to a database. The application will also take a short video (3-5 second GIF) which shows the hard drive being put inside the shredder to be destroyed.

The system includes a camera positioned to record image information of a memory device being placed into a shredder. A controller receives the image information from the camera and processes the image information to identify a unique identifier (e.g., a serial number, a QR code®, a barcode, etc.) and correlate the unique identifier to the memory device and the captured image information. The camera then captures video information of the shredding or destruction process of the memory device. The captured video information is then saved and correlated to the unique identifier in an information management system. Users can then recall proof (e.g., the image information and the video information) of the destruction of the memory device.

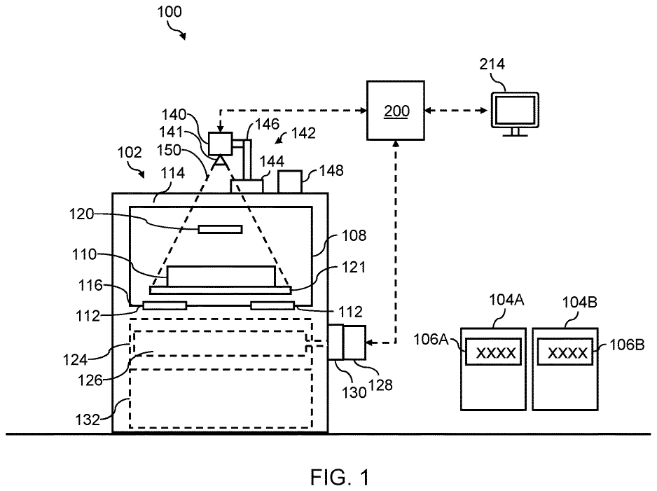

As shown in FIG. 1, a disposal system 100 includes a shredder 102, a camera 140, and a controller 200. The shredder 102 is configured to destroy electronic memory devices 104 (see 104A and 104B in FIG. 1). In some implementations, the electronic memory device 104 is a hard disk drive (HDD), solid state drive (SSD), universal serial bus (USB) drive, random access memory (RAM), a cache memory, a read-only memory (ROM), flash memory, an optical disk, or other memory devices. The electronic memory device 104 includes a unique visual identifier in the form of a barcode 106. In some implementations, the unique visual identifier includes a quick response (QR) code®, an alphanumeric code, a serial number, a graphic, or another visual identifier. In some implementations, the electronic memory device 104 includes multiple unique visual identifiers (e.g., QR codes, barcodes, stock keeping units, serial numbers, etc.).

The shredder 102 includes a shredder door 108 that is movable between a closed position and an open position. In some implementations, the shredder door 108 is mounted to the shredder 102 on a hinge 112 that pivotably couples the shredder door 108 to a shredder frame 114 along the bottom edge 116 of the shredder door 108. The shredder door 108 includes a handle 120 that projects outwardly and is graspable by a user. The shredder door 108 includes a platform 121 mounted to the shredder door 108. A self-closing slot 110 is formed in the shredder door 108 above the platform 121 and sized to receive the electronic memory device 104. In some implementations, the shredder door 108 is eliminated and the self-closing slot 110 is formed into a panel of the shredder 102 above the platform 121. In some implementations, the platform 121 includes a conveyor belt system configured to direct electronic memory devices 104 to and/or through the slot 110. As described in additional detail herein, the conveyor system of the platform 121 may be operated by the controller 200.

The shredder 102 includes a shredder chamber 124 housing at least one cutter 126 (e.g., a rotatable cutter). The cutter 126 is driven to rotate by at least one motor 128. In some implementations, the motor 128 is coupled to the cutters 126 through a transmission 130. In some implementations, the transmission 130 is a gearbox, belt and pulley system, chain and sprocket system, or other suitable transmission system.

The shredder 102 includes a container 132 defining a volume configured to receive shredded material from the shredder chamber 124. The container 132 may facilitate transporting the shredded material. For example, the container 132 may include wheels.

The camera 140 is positioned to capture image information within a field of view 150. In some implementations, the field of view 150 is sized to encompass the electronic memory device 104 when positioned on the platform 121 adjacent the self-closing slot 110. The camera 140 is supported above the shredder 102 by a vibration damper 142. In some implementations, the vibration damper 142 may be or include a base 144 and an arm 146. In some implementations, the base 144 is magnetic. In some implementations, the base 144 is elastomeric coated (e.g., rubber coated). In some implementations, the rubber coating of the base 144 absorbs vibrations. The base 144 may couple to the arm 146 (e.g., via ¼-20 threading), and may have a magnetic holding capacity of approximately 40 lbs. In some implementations, the camera 140 is a high-quality industrial camera (e.g., a Basler camera) connected to the controller 200 using ethernet connection and configured using a Basler camera Pylon application. In some implementations, the image information is approximately 1.4 MB and/or has a resolution of 2448 pixels by 2048 pixels. In some implementations, the size of the video file ranges between 700 KB and 950 KB and/or has a resolution of 573 pixels by 480 pixels. In some implementations, the video file has a framerate of 23 frames per second.

In some implementations, the disposal system 100 includes a light 148 that illuminates at least a portion of the field of view 150 of the camera 140. For example, the light 148 may include at least one light emitting device (e.g., a light emitting diode, florescent bulb, halogen bulb, infrared light, etc.). The light 148 may be coupled to the shredder frame 114. In some implementations, the light 148 is coupled to the camera 140 and/or is mounted on the arm 146.

The controller 200 controls operation of the shredder 102 and a user can interact with the controller 200 via a user interface 214. In some implementations, the controller 200 communicates with the camera 140 to operate the camera 140 and receive image information, and with the motor 128 to activate and deactivate the cutter 126.

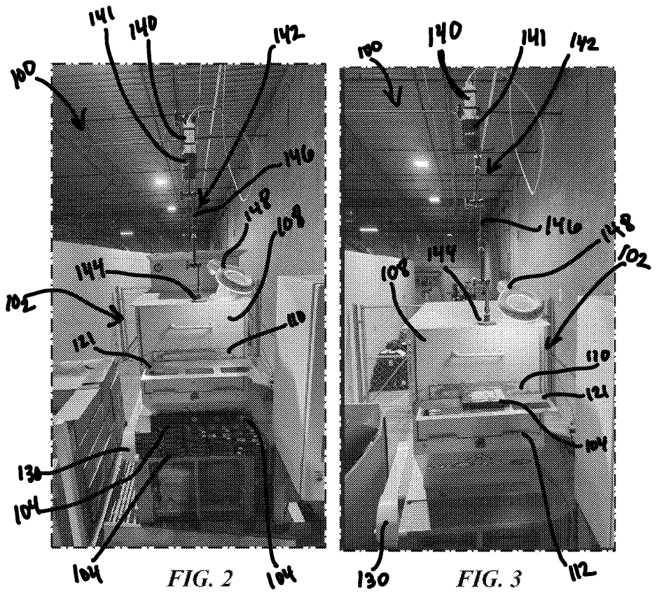

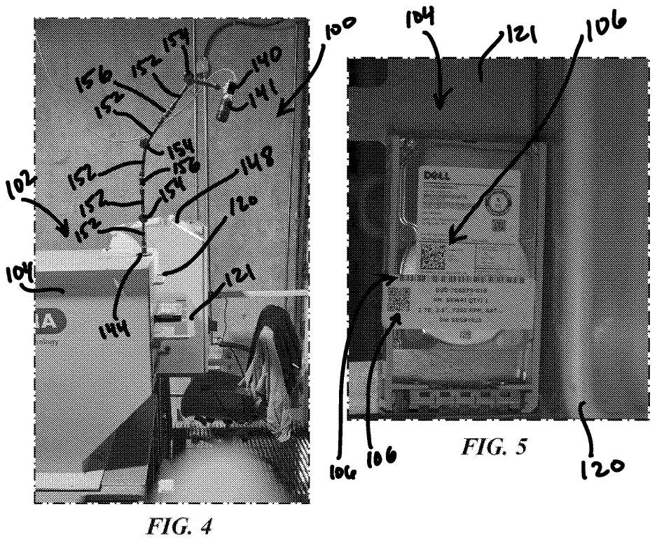

As shown in FIGS. 2 and 3, the platform 121 extends from a front of the shredder frame 114 (e.g., the shredder door 108) and provides space for a user to place the electronic memory device 104 thereon. The light 148 illuminates the electronic memory device 104 within the field of view 150 of the camera 140, and the camera 140 is controlled to capture image information.

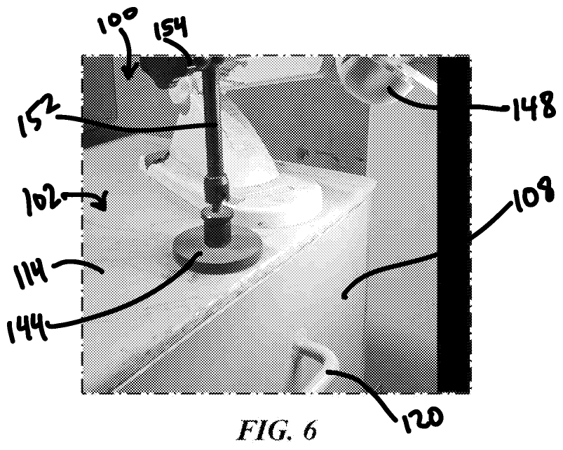

As shown in FIG. 4, in some implementations, the arm 146 includes arm segments 152 linked together with locking elbows 154 and vibration absorbing joints 156. The vibration absorbing joints may include a vibration dampening material (e.g., foam, an elastomer, etc.) that dampens axial vibrations, transverse vibrations, and/or torsional vibrations. In some implementations, the arm 146 is tuned to reduce or deaden vibrations at the frequency produced by the shredder 102. In some implementations, the articulating arms segments are 11 inches long. In some implementations, the arm 146 includes ¼-20 metallic wing nuts that improve the durability, capacity, and weight distribution of the arm 146. In some implementations, the arm 146 includes one or more arm segments 152 (e.g., two, three, four, five, six, seven, eight, ten, etc.).

With continued reference to FIG. 4, the camera 140 includes a lens 141. The lens 141 may be a wide-angle lens. For example, the lens 141 may be a Basler C11-3520-12M (35 mm) lens, a Basler C11-2520-12M (25 mm) lens, or a Basler C11-1620-12M (16 mm) lens. A 35 mm lens has a longer focal length than a 25 mm lens or a 16 mm lens, so, all else being equal, the 35 mm lens will provide a narrower field of view than the 25 mm lens and the 16 mm lens. The focal length of the lens 141 may be static or variable, and the lens 141 may be adjustable and/or interchangeable to accommodate a variety of photo and video conditions. In some implementations, the camera 140 is a Basler Ace aca2440-20gm Color Camera. In some implementations, the camera 140 is suspended above the platform 121 by the arm 146.

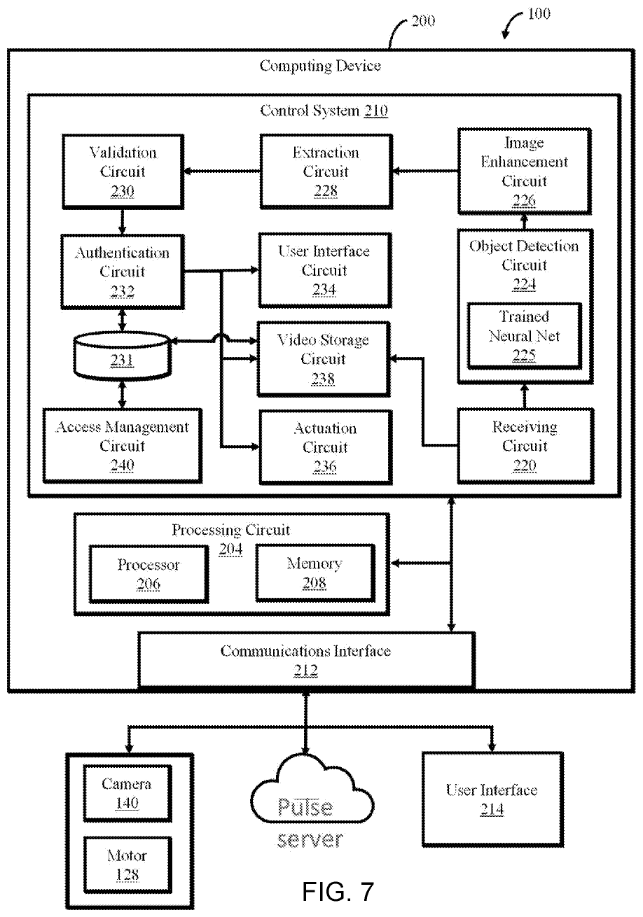

As shown in FIG. 5, the electronic memory device 104 includes the barcode 106. In some implementations, the barcode 106 includes a sticker or is otherwise applied to the electronic memory device 104 by the user. For example, the user may receive the electronic memory device 104 from a client, create the barcode 106 that is cross referenced to a serial number or other client identifier of the electronic memory device 104, and apply the barcode 106 to the electronic memory device 104. The barcode 106 is placed in an area of the electronic memory device 104 that is easily placed within the field of view 150 of the camera 140. In some implementations, the barcode 106 is on a sticker and may be shaped or sized to cover or obscure other visual identifiers (e.g., SKU's, barcodes, manufacturer barcodes, etc.) that may be present on the electronic memory device 104. For example, a sticker including the barcode 106 may cover and obscure some or all of the surface area of the electronic memory device 104 that contains manufacturer markings that is not the barcode 106. In other implementations, one or more of the manufacturer markings are adopted and serve as the barcode 106. In some implementations, the controller 200 is configured to only recognize the barcode 106 and will ignore any other barcode/QR code on the electronic memory device 104.

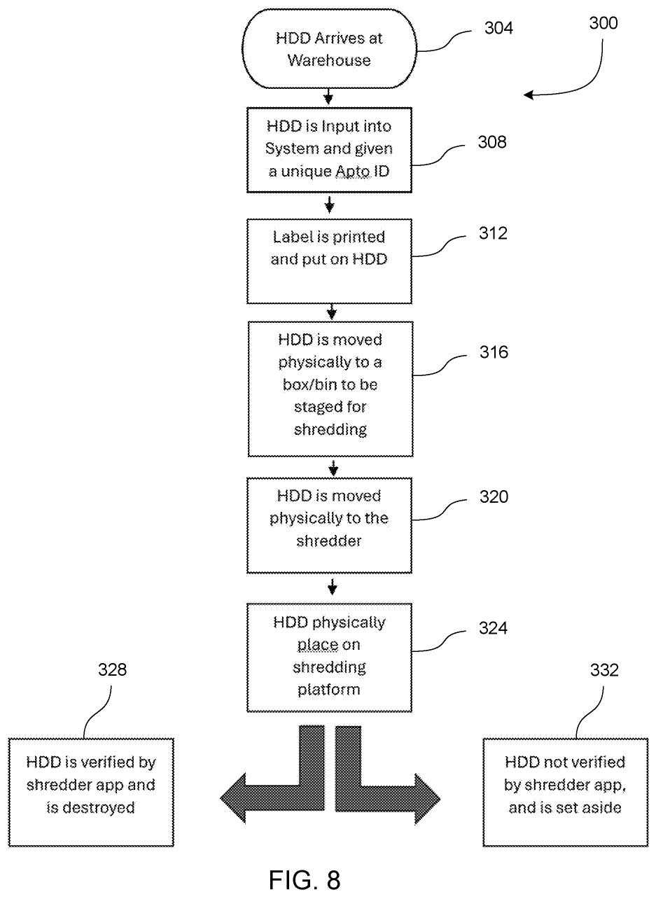

As shown in FIG. 6, in some implementations, the shredder frame 114 is made of steel or another ferrous metal and the base 144 of the vibration damper 142 is magnetic to hold the vibration damper 142 in place during use. In some implementations, the light 148 also includes a magnetic base.

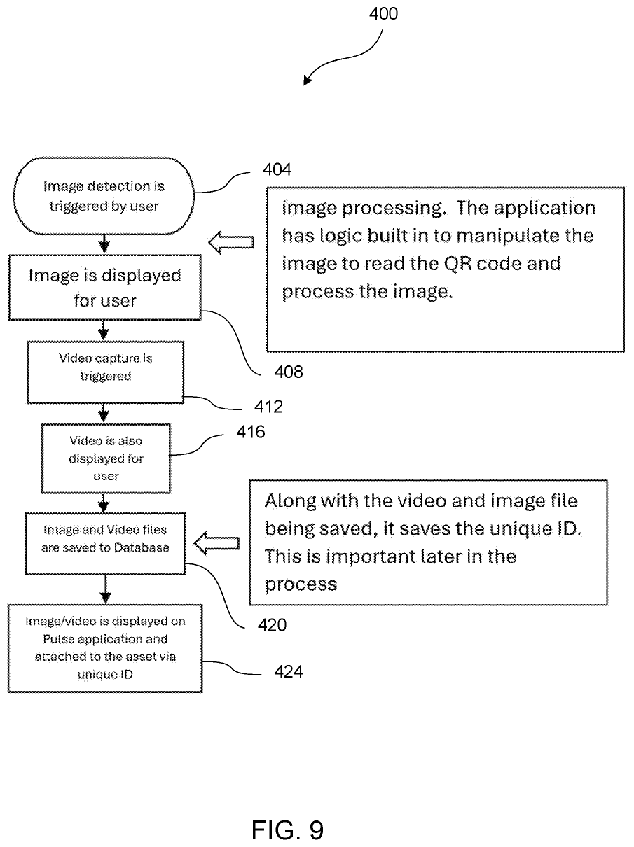

As shown in FIG. 7, the controller 200 includes a processing circuit 204 having a processor 206 and a memory device 208, a control system 210 having a receiving circuit 220, an object detection circuit 224, an image enhancement circuit 226, an extraction circuit 228, a validation circuit 230, an authentication circuit 232, an operations data database 231, a user interface circuit 234, an actuation circuit 236, a video storage circuit 238, an access management circuit 240, and a communications interface 212 including a user interface 214. Generally, the controller 200 is structured to operate the camera 140, motor 128, and user interface 214.

In one configuration, the circuits of the control system 210 are in the form of machine or computer-readable media that is executable by a processor, such as processor 206. The machine-readable media facilitates performance of operations to enable reception and transmission of data. For example, the machine-readable media may provide an instruction (e.g., command, etc.) to acquire data. The computer readable program code may be executed on one processor, multiple co-located processors, multiple remote processors, or any combination of local and remote processors. Remote processors may be connected to each other through any type of network (e.g., CAN bus, etc.).

In another configuration, the circuits of the control system 210 are implemented as hardware units, such as electronic control units. As such, the circuits of the control system 210 may be implemented as one or more circuitry components including, but not limited to, processing circuitry, network interfaces, peripheral devices, input devices, output devices, sensors, etc. In some implementations, the circuits of the control system 210 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The circuits of the control system 210 may also include programmable hardware devices such as field programmable gate arrays, programmable array logic, programmable logic devices or the like. The circuits of the control system 210 may include one or more memory devices for storing instructions that are executable by the processor(s) of the circuits of the control system 210. In some hardware unit configurations, the circuits of the control system 210 may be geographically dispersed throughout separate locations. Alternatively, and as shown, the circuits of the control system 210 may be implemented in or within a single unit/housing, which is shown as the controller 200. In some implementations, the controller 200 is coupled to the shredder 102. In some implementations, the user interface 214 is coupled to the shredder 102.

In the example shown, the controller 200 includes the processing circuit 204 having the processor 206 and the memory device 208. The processing circuit 204 may be structured or configured to execute or implement the instructions, commands, and/or control processes described herein with respect to the circuits of the control system 210. The depicted configuration represents the circuits of the control system 210 as machine or computer-readable media. However, as mentioned above, this illustration is not meant to be limiting as the present disclosure contemplates other implementations where the circuits of the control system 210, or at least one circuit of the circuits of the control system 210, is configured as a hardware unit. All such combinations and variations are intended to fall within the scope of the present disclosure.

The hardware and data processing components used to implement the various processes, operations, illustrative logics, logical blocks, modules and circuits described in connection with the implementations disclosed herein (e.g., the processor 206) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration.

The memory device 208 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 208 may be communicably connected to the processor 206 to provide computer code or instructions to the processor 402 for executing at least some of the processes described herein. Moreover, the memory device 208 may be or include tangible, non-transient volatile memory or non-volatile memory. Accordingly, the memory device 208 may include database components, object code components, script components, or any other type of information structure for supporting the various activities and information structures described herein.

The receiving circuit 220 is structured to control operation of the camera 140 and to receive image information (e.g., still photos and videos) from the camera 140. The receiving circuit 220 provides the image information to the object detection circuit 224 and the video storage circuit 238. In some implementations, the image information includes a still image, a looped video recording, a series of still images assembled into a .gif file, another animation format, or other image format that can be provided for storage and reference within the video storage circuit 238.

The object detection circuit 224 is structured to receive the image information from the receiving circuit 220 and includes a machine learning model 225. The machine learning model 225 may be a deep learning model such as a convolutional neural network (CNN), a real-time object identification model, or another model that can be used to detect shapes or patterns. For example, the machine learning model 225 can be a you-only-look-once (YOLO) object detection model (e.g., a YOLOv7 object detection model). The machine learning model 225 is trained on training pairs of images of electronic memory devices 104 including barcodes 106 as the input and bounding boxes as the output. In some implementations, the machine learning model 225 is trained using at least 1,000 training pairs and is purpose-built for detecting electronic memory devices 104 from the image information. In some implementations, the object detection circuit 224 is configured to output an isolated image of the electronic storage device 104 and barcode 106 from the image information, and may adjust scaling and orientation to flatten and/or straighten the image information or a portion of the image information. For example, if the electronic memory device 104 is not centered within the field of view 150 of the camera 140, the object detection circuit may flatten or straighten the portion of the image information where an electronic memory device 104 is detected.

In some implementations, the machine learning model 225 uses an advanced object detection model called YOLOv7 (You Only Look Once version 7) to identify the electronic memory device 104 within the captured image (i.e., image information). YOLOv7 can accurately detect various objects by analyzing the image and pinpointing the location of the electronic memory device 104 in the form of bounding boxes containing area of interest. Yolov7 is a state of art open-source object detection model. In some implementations, the machine learning model 225 is structured to detect the electronic memory device 104 using yolov7 model using the image coming from the camera 140 (e.g., a Basler camera) and returns bounding boxes if the image contains the electronic memory device 104, else it will return null.

The image enhancement circuit 226 is structured to the receive the processed image information from the object detection circuit 224. The image enhancement circuit 226 processes the image information to adjust at least one of the image straightness, brightness, sharpness, saturation, noise reduction, contrast of the received image information, etc. In some implementations, the image enhancement circuit 226 transforms the image information to be monochromatic (e.g., greyscale) or makes other color adjustments. For example, a first step may be to perform contrast improvement. In some implementations, the image enhancement circuit uses opencv's cv2 library (e.g., cv2.createCLAHE(clipLimit=2.0, tileGridSize=(8,8))). Further in this example, a second step may be to perform grayscale of the image processed in step 1, which is a black and white image. For example, (gray_image=cv2.cvtColor(image, cv2.COLOR_BGR2GRAY)). In some implementations, these enhancements may make the QR code® more distinct and visible.

The extraction circuit 228 is structured to receive the processed image information from the image enhancement circuit 226 and extract a processed unique identifier (e.g., the enhanced image of the barcode 106). The extraction circuit 228 can use pattern recognition techniques to detect and decode the image information of the barcode 106 (e.g., or another unique visual identifier). In some implementations, the extraction circuit 228 is structured to read the barcode 106 including a QR code®. For example, the extraction circuit 228 can use the Pyzbar Library in Python. In some implementations, the barcode 106 including the QR code® is a “Standard QR code” and it is decoded using Pyzbar.decode( ). Pyzbar is designed to decode the information embedded in QR codes by analyzing the pattern of black and white squares. This step extracts the data stored in the barcode 106 including the QR code®. In some implementations, the extraction circuit 228 extracts the Proprietary ID which is stored in the barcode 106 including the QR code®.

The validation circuit 230 is structured to receive the processed unique identifier from the extraction circuit 228 and to validate the extracted processed unique identifiers by pattern matching to ensure the extracted processed unique identifier follows an expected format and is accurate. For example, the validation circuit 230 may utilize regular expression techniques. For example, when the processed unique identifier is a Proprietary ID, once the Proprietary ID is extracted, the validation circuit 230 may validate it by performing pattern matching using regular expression. Regular expression-based pattern matching helps to validate only specific pattern (e.g., the Proprietary ID) to ensure it is correct and follows the expected format. Regular expression is a sequence of symbols and characters expressing a string or pattern to be searched for within a piece of text. In some implementations, the validation circuit 230 may utilize regex library from python and utilize regex.findall( ) to find a relevant pattern. Regular expressions help ensure that the retrieved processed unique identifier follows the expected format and is accurate. This validation step can confirm that the processed unique identifier (e.g., the Proprietary ID) is legitimate and ready for further processing.

The authentication circuit 232 receives a validated identifier from the validation circuit 230 and checks the validated identifier against a set of expected identifiers. For example, the authentication circuit 232 may query the operations data database 231 to determine whether the validated identifier is an identifier from a set of identifiers associated with an inventory of electronic memory devices 104. For example, after the validation circuit 230 validates the Proprietary ID, the authentication circuit 232 may check its presence in specific tables within the operations data database 231. In some implementations, the authentication circuit 232 may look for the Proprietary ID in a “sold_inventory” and “equip_inventory” tables. The authentication circuit 232 ensures that the Proprietary ID corresponds to a record in one or more tables of the operations data database 231, confirming its authenticity.

In some implementations, the database 231 is an SQL server database. The connection between the backend code and the operation data database 231 may be established using the pymssql library in Python. pymssql is a reliable library that facilitates seamless communication with the SQL Server database, allowing the circuits of the control system 210 to perform queries and retrieve data efficiently.

In some implementations, the authentication circuit 232 is configured to update the operations data database 231. For example, the authentication circuit 232 may create an entry in a table (e.g., a “shredder_details” table) when image information is saved. In some implementations, the entry includes values corresponding to categories such as a counter id, image path, Is_barcode_detected, Is_barcode_found, Proprietary_id, a timestamp, and a video path. In some implementations, the entry may include at least one of a counter id, image path, Is_barcode_detected, Is_barcode_found, Proprietary_id, a timestamp, or a video path, or combinations and subcombinations thereof.

In some implementations, the counter id is an auto-incremented unique identifier for each entry. The counter id may serve as the SQL primary key, ensuring that each record in the table can be uniquely identified.

In some implementations, the image path column stores the location on the Pulse server where the image(s) of the hard drive is saved. The image path specifies the path to access the stored image for display via a portal (e.g., a Recycling Certification page of the Pulse portal).

In some implementations, the Is_barcode_detected column indicates whether a QR code® was detected in the image. For example, the value can be “1” if the QR code® was detected successfully, otherwise, the value can be “0”. In some implementations, the authentication circuit 232 and video storage circuit 238 save the image and video to the operations data database 231, and if the Is_barcode_detected column is “0”. It means there is no associated data in the database, and thusly will not display to any asset in the Pulse application.

In some implementations, the Is_barcode_found column indicates whether the Proprietary ID was found in the equip_inventory or sold_inventory tables. The value will be “1” if the Proprietary ID was found, otherwise, it will be “0”.

In some implementations, the Proprietary_id column stores the Proprietary ID of the scanned hard drive. For example, it may contain the Proprietary ID extracted from a QR code® and authenticated by the authentication circuit 232.

In some implementations, the Timestamp column records the exact time when the QR code® was scanned and stored in the column against scanned Hard Drive in YYYY/MM/DD format.

In some implementations, the video_path column stores the location where the video of the hard drive being shredded is saved on the Pulse server which can be viewed via a portal (e.g., via a Recycling Certification page of the Pulse portal). It specifies the path to access the stored video.

The video storage circuit 238 is structured to control storage and retrieval or image information to/from the operations data database 231. For example, the video storage circuit 238 may store video data and photo data in the operations data database 231. In some implementations, when the video storage circuit 238 attempts to save an image or video to the operations database 231, the video storage circuit 238 may check for a success status in the code. The success status indicates whether the saving process was successful. Advantageously, checking the success status when the video storage circuit 238 attempts to save the video and/or image can quickly detect failures that may lead to a loss of image information of the destruction of one or more of the electronic storage devices. In some implementations, if the saving process fails, the operations data database 231 or video storage circuit 238 generates an exception message. The video storage circuit 238 is designed to handle this exception using try-except exception handling technique. In some implementations, when an exception occurs, the video storage circuit 238 handles the exception and sends feedback to the application programming interface (API). This feedback may inform a “/save_metadata” API about the failure, which communicates the exception back to the application for presenting a failure status message at a frontend (e.g., “Failed to save image and video”). In some implementations, responsive to the detection of a save failure, the video storage circuit 238 may transfer at least a portion of a loop recording from a loop recording working partition to a loop recording retention partition that is not overwritten during loop recording. In some implementations, the loop recording may provide a backup and may be of a parallel video stream provided by the receiving circuit 220 from the camera 140. In some implementations, the entire process of checking the success status, handling exceptions, and sending feedback occurs in the backend python code of the application.

In some implementations, the video storage circuit 238 first saves the image and video by the name of Proprietary ID, as it is unique to the electronic storage device. Then the video storage circuit 238 connects to a server (e.g., a Pulse Server) and sends these images and video to the Pulse server. It will generate an exception if it fails to upload the image and video files to the Pulse server and with that the backend API will return success or failed messages.

The actuation circuit 236 controls one or more actuators of the disposal system 100. For example, the actuation circuit 236 controls the motor 128. In some implementations, the actuation circuit 236 controls actuators to lock and unlock the self-closing slot 110. In some implementations, the actuation circuit 236 controls actuators to operate a conveyor belt, a pusher, a diverter, etc., to selectively direct the electronic memory device 104 to the shredder 102 or to a receptacle.

In some implementations, the actuation circuit 236 is structured to actuate a component of the platform 121 to prevent the electronic memory device 104 from being shredded by the shredder 102. For example, the platform 121 may be or include a conveyor system including one or more sensors and one or more actuators, and the controller 200 may display an alert that prevents the electronic memory device 104 from being shredded by the shredder 102. In this example, the alert may be a fault code that pauses the conveyor, activates a pusher, a diverter, etc., of the conveyor system of the platform 121.

In some implementations, the conveyor system 121 includes a detection sensor (e.g., a proximity sensor) configured to detect the presence of an electronic memory device 104 within a field of view of the detection sensor. The controller 200 may be further configured prevent the conveyor system from delivering the electronic memory device 104 to the shredder 102 and may instead deliver the electronic memory device 104 to a receptacle of electronic memory devices (e.g., by actuating an actuator that kicks the electronic memory device 104 off the belt and into a reject bin) for special processing based on a failed authentication of the barcode 106.

In some implementations, the alert is a message displayed on a display and is perceivable by an operator that is proximate to the shredder 102, and thereby may prevent the electronic memory device 104 from being deposited into the shredder 102 for shredding. In some implementations, the motor 128 is operated continuously and the controller 200 is structured to selectively permit the electronic memory device 104 from accessing the shredder 102.

The access management circuit 240 may be configured to authenticate a user based on a received set of login credentials (e.g., a username and password). For example, the access management circuit 240 may determine whether the received login credentials match the login credentials of an authorized user. In some implementations, the access management circuit 240 may permit access to a web application configured to present portions of the database 231 that are associated with an authenticated user.

The user interface circuit 234 is configured to produce one or more screens of a graphics user interface and provide communication to and from a user. For example, once the backend confirms that the image or video has been successfully saved, the video storage circuit 238 may display a confirmation message on the frontend. For example, the message “Image and video saved successfully” can be shown to inform a user that the saving process was completed without encountering an exception. As another example, if the image and video fail to upload to the pulse server, the user interface circuit 234 may present a message (e.g., “Failed to save image and video”). In some implementations, if the validated identifier is successfully authenticated by the authentication circuit 232, the user interface circuit 234 may produce a message that includes the validated identifier on a on one or more screens of a graphics user interface.

In some implementations, the user interface circuit 234 is structured to present web pages that integrate with the API endpoints. For example, the user interface circuit 234 may present a login page. The login page may allow a user to enter login credentials (e.g., a username and password). If the user is successfully authenticated, then the user interface circuit 234 may redirect to the home page else it may display an indication of invalid credentials (e.g., incorrect user name or password). In some implementations, the home page includes two fields. One field may show the image information captured using camera 140, and the other field may show image information corresponding to a video of a previously recorded hard drive and/or a recently recorded hard drive.

In some implementations, the backend is built using python with MSSQL database being utilized for storing the Hard drive metadata into shredder_details table. It contains five primary API endpoints which are served and integrated to front-end scripts in Angular.

While various circuits with particular functionality are shown in FIG. 7, it should be understood that the controller 200 may include any number of circuits for completing the functions described herein. For example, the activities and functionalities of the circuits of the control system 210 may be combined in multiple circuits or as a single circuit. Additional circuits with additional functionality may also be included. Further, the controller 200 may further control other activity beyond the scope of the present disclosure.

As mentioned above and in one configuration, the “circuits” may be implemented in machine-readable medium for execution by various types of processors, such as the processor 206 of FIG. 7. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be implemented in any suitable form and organized within any suitable type of data structure. The operational data may be collected as a single data set, or may be distributed over different locations including over different storage devices, and may exist, at least partially, merely as electronic signals on a system or network.

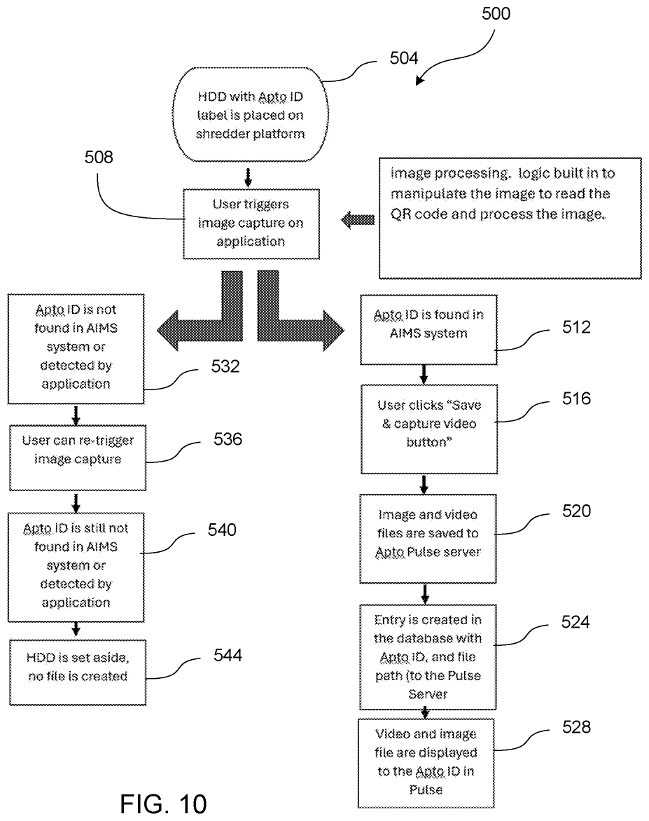

As shown in FIG. 8, a electronic memory device processing method 300 includes physically receiving the electronic memory device 104 at step 304, and inputting the unique identifier of the electronic memory device 104 into the controller 200 (e.g., the operations data database 231 via the user interface circuit 234) at step 308. For example, step 308 can include saving a serial number of the electronic memory device 104 and an corresponding Proprietary ID in the operations data database 231 for use by the controller 200.

At step 312, the barcode 106 is printed (e.g., a label) and applied to the electronic memory device 104 and then the electronic memory device 104 is stored or staged for shredding at step 316. Once the electronic memory device 104 is called for destruction, the electronic memory device 104 is moved at step 320 to the area of the shredder 102. At step 324, the electronic memory device 104 is placed on the platform 121 and the user operates the controller 200 to capture an image of the barcode 106, detect the image using the object detection circuit 224, enhance the image using the image enhancement circuit 226, extract the image using the extraction circuit 228, validate the image using the validation circuit 230, and authenticate the image using the authentication circuit 232.

At step 328, the electronic memory device 104 and associated barcode 106 is authenticated by the authentication circuit 232 and the electronic memory device 104 is destroyed by activating the motor 128 and moving the electronic memory device 104 through the self-closing slot 110. The camera 140 captures a video of the destruction and stores the video to the operations data database 231 via the video storage circuit 238.

At step 332, the electronic memory device 104 and associated barcode 106 is not authenticated or otherwise fails one of the steps to authentication. If the controller 200 cannot authenticate the electronic memory device 104, then the electronic memory device 104 is set aside for manual inspection.

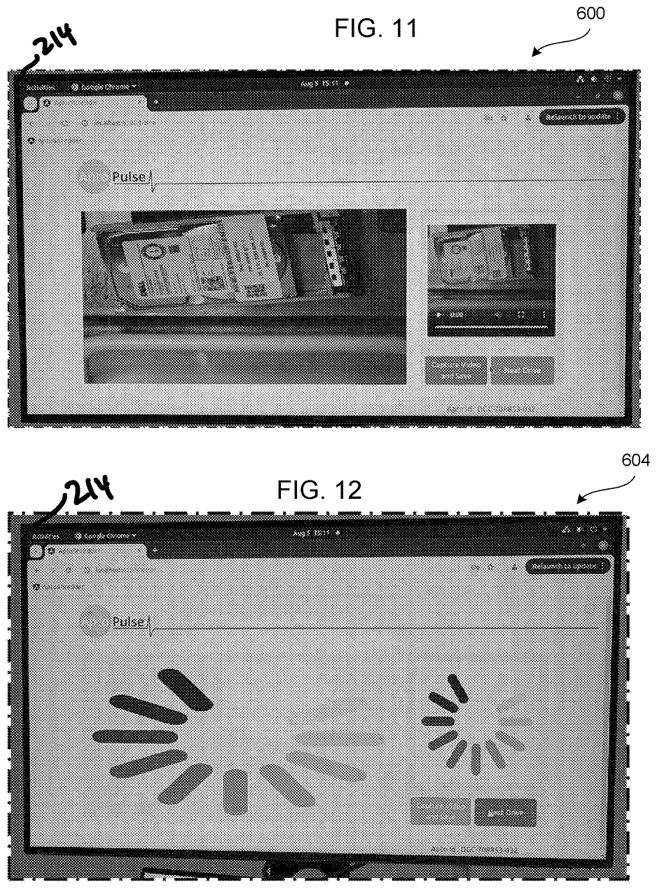

As shown in FIG. 9, an information processing method 400 including triggering image detection at step 404. In some implementations, triggering image detection is completed by a user via the user interface 214 and the user interface circuit 234. For example, once the electronic memory device 104 is arranged on the platform 121, the user may press a button in the graphical user interface of the user interface 214 to record the image information that is then processed by the controller 200 to authenticate the electronic memory device 104. At step 408, if the image information is authenticated the processed image information is displayed on the graphical user interface of the user interface 214 and saved to the operations data database 231.

At step 412, video recording by the camera 140 is triggered. This can be accomplished manually via a button in the graphical user interface of the user interface 214 or automatically once the electronic memory device 104 is authenticated.

At step 416, the live video recording is displayed on the graphical user interface of the user interface 214. At step 420, the recorded video is saved to the operations data database 231 and associated with the unique identifier, an processed image information of the electronic memory device 104.

At step 424, the user can access the operations data database 231 to recall and view the images, videos, and unique identifier of the electronic memory device 104 to confirm and verify destruction at a later time.

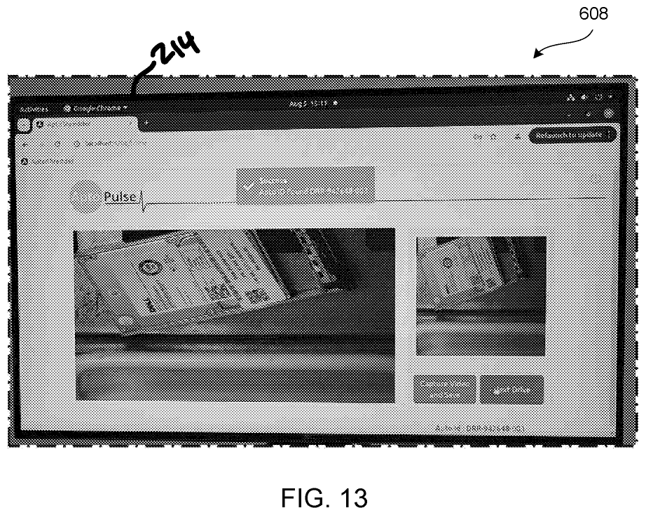

As shown in FIG. 10, another information processing method 500 includes receiving the electronic memory device 104 on the platform 121 at step 504 and triggering authentication of the electronic memory device 104 via the controller 200 at step 508.

At step 512, the unique identifier is authenticated. At step 516, the user clicks a save and capture button on the graphical user interface of the user interface 214 and the electronic memory device 104 is shredded. At step 520, the images and video are saved to the operations data database 231 and associated with the unique identifier. At step 524, an entry is updated in the operations data database 231. At step 528, the user can query the operations data database 231 via a graphical user interface of the user interface 214 to recall the entry and display the information associated with the destruction of the electronic memory device 104 (e.g., images, video, proprietary ID, notes, etc.).

At step 532, the electronic memory device 104 is not authenticated by the controller 200. At step 536, the user can retrigger the authentication process in an attempt to authenticate the electronic memory device 104. At step 540, the electronic memory device 104 is still not authenticated, and at step 544 the electronic memory device 104 is set aside for manual inspection.

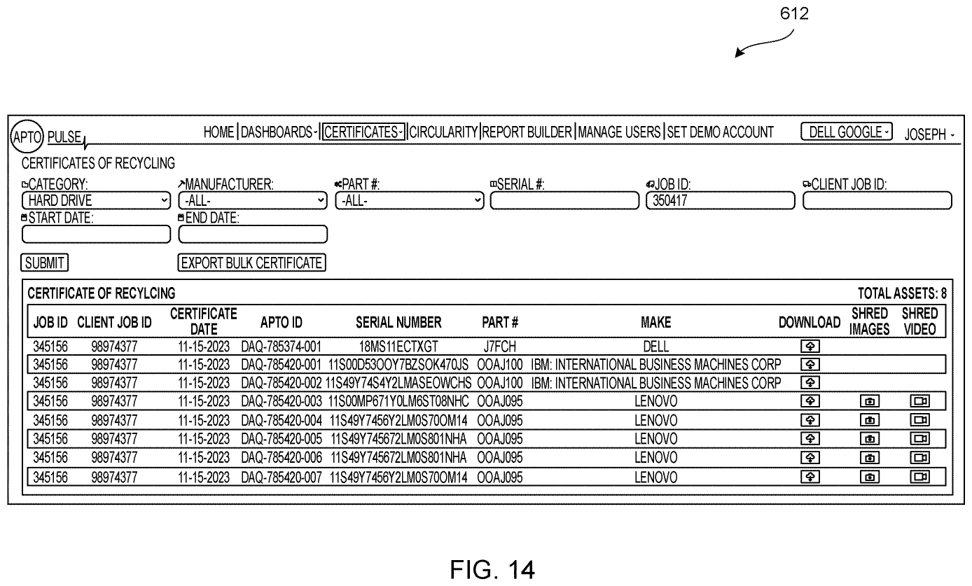

As shown in FIG. 11, an electronic memory device 104 is shown in a graphical user interface 600 and allows the user to capture the image information. As shown in FIG. 12, a graphical user interface 604 shows the user that the authentication process is in progress by the controller 200. As shown in FIG. 13, a graphical user interface 608 shows the user that the electronic memory device 104 is authenticated and they can begin capturing video and save the processed image information. In some implementations, once the video is enabled, then the shredder 102 can be turned on to destroy the electronic memory device 104. In some implementations, the shredder 102 cannot be turned on unless the electronic memory device 104 is authenticated. In some implementations, the self-closing slot 110 is locked shut unless the electronic memory device 104 is authenticated. In some implementations, the controller 200 is structured to display a message such as “hold” or “wait” or “processing” on a display device of the user interface 214 until the electronic memory device 104 is authenticated. As shown in FIG. 14, a graphical user interface 612 allows the user to query the operations data database 231 to recall entries and review the status of a particular electronic memory device 104 (e.g., 104A, 104B, etc.), view processed image information, view video, read notes, etc.).

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as utilized herein to describe various implementations, are intended to indicate that such implementations are possible examples, representations, or illustrations of possible implementations (and such terms are not intended to connote that such implementations are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary implementations, and that such variations are intended to be encompassed by the present disclosure.

The hardware and data processing components used to implement the various processes, operations, illustrative logics, logical blocks, modules and circuits described in connection with the implementations disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, or microcontroller. A processor may also be implemented as a combination of computing devices, such as a combination of a DSP and a microprocessor, multiple microprocessors, one or more microprocessors in conjunction with a DSP core, or any other such configuration. In some implementations, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers, and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit or the processor) the one or more processes described herein.

The present disclosure contemplates methods, system and program products on any machine-readable media for accomplishing various operations. The implementations of the present disclosure may be implemented using existing computer processors, or by a special purpose computer processor for an appropriate system, incorporated for this or any other purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data that cause a general purpose computer, special purpose computer, or special purpose processing machine to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the disposal system 100 as shown in the various exemplary implementations is illustrative only. Additionally, any element disclosed in one implementation may be incorporated or utilized with any other implementation disclosed herein. Although only one example of an element from one implementation that can be incorporated or utilized in another implementation has been described above, it should be appreciated that other elements of the various implementations may be incorporated or utilized with any of the other implementations disclosed herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A disposal system for an electronic memory device, the disposal system comprising:
a shredder configured to destroy the electronic memory device and including an opening sized to receive the electronic memory device and a platform positioned adjacent to the opening;
a camera coupled to the shredder and defining a field of view at least as large as the opening, the camera configured to capture image information associated with the electronic memory device and video information; and
one or more processing circuits comprising one or more memory devices coupled to one or more processors, the one or more memory devices configured to store instructions thereon that, when executed by the one or more processors, cause the one or more processors to:
receive the image information from the camera;
process a unique identifier from the image information using object detection;
authenticate the processed image information;
receive the video information from the camera when the processed image information is authenticated; and
save the processed image information, the video information, and the unique identifier for later recall.

2. The disposal system of claim 1, wherein the shredder includes a motor driving a cutter.

3. The disposal system of claim 2, wherein the one or more memory devices are further configured to store instructions thereon that, when executed by the one or more processors, cause the one or more processors to inhibit operation of the motor if the processed image information is not authenticated.

4. The disposal system of claim 2, wherein the one or more memory devices are further configured to store instructions thereon that, when executed by the one or more processors, cause the one or more processors to control operation of the camera to capture video information after the processed image information is authenticated.

5. The disposal system of claim 4, wherein the one or more memory devices are further configured to store instructions thereon that, when executed by the one or more processors, cause the one or more processors to inhibit operation of the motor if the video information is not being captured.

6. The disposal system of claim 1, wherein the one or more memory devices are further configured to store instructions thereon that, when executed by the one or more processors, cause the one or more processors to control operation of the camera to capture the image information when the electronic memory device is positioned on the platform.

7. The disposal system of claim 1, wherein the camera is mounted to the shredder by a vibration damper.

8. The disposal system of claim 7, wherein the vibration damper includes an arm and a magnetic base.

9. The disposal system of claim 1, further comprising a light illuminating the field of view of the camera.

10. The disposal system of claim 1, wherein the one or more memory devices are further configured to store instructions thereon that, when executed by the one or more processors, cause the one or more processors to:
process the image information using a machine learning model to identify the unique identifier.

11. The disposal system of claim 10, wherein the machine learning model is a you-only-look-once object detection model.

12. The disposal system of claim 10, wherein the one or more memory devices are further configured to store instructions thereon that, when executed by the one or more processors, cause the one or more processors to:
enhance the processed image information; and
extract the unique identifier from the enhanced, processed image information.

13. The disposal system of claim 12, wherein the one or more memory devices are further configured to store instructions thereon that, when executed by the one or more processors, cause the one or more processors to:
validate the unique identifier against a pre-stored database and inhibit authentication if the unique identifier is not validated.

14. The disposal system of claim 1, wherein the electronic memory device includes a quick response (QR) code® and the image information includes the QR code®, and
wherein the one or more memory devices are further configured to store instructions thereon that, when executed by the one or more processors, cause the one or more processors to extract the unique identifier from the QR code®.

15. The disposal system of claim 1, wherein the one or more memory devices are further configured to store instructions thereon that, when executed by the one or more processors, cause the one or more processors to:
save the processed image information, the video information, and the unique identifier to a database;
query the database in response to a user request; and
generate a graphical user interface showing the processed image information, the video information, and the unique identifier in response to the query.

16. A system comprising:
one or more processing circuits comprising one or more memory devices coupled to one or more processors, the one or more memory devices configured to store instructions thereon that, when executed by the one or more processors, cause the one or more processors to:
receive image information from a camera via a receiving circuit;
identify a quick response (QR) code® image within the image information using a machine learning model;
enhance the QR code® image via an image enhancement circuit to generate an enhanced QR code® image;
extract a unique identifier from the enhanced QR code® image via an extraction circuit;
query a database with the unique identifier via an authentication circuit and return an authenticate code or a null code indicating no authentication;
control the camera to record video information in response to receiving the authenticate code;
control a motor of a shredder in response to receiving the authenticate code; and
save the image information, the video information, and the unique identifier to the database.

17. The system of claim 16, wherein the one or more memory devices are further configured to store instructions thereon that, when executed by the one or more processors, cause the one or more processors to:
validate the unique identifier using expression-based pattern matching via a validation circuit before querying the database with the unique identifier via the authentication circuit.

18. The system of claim 16, wherein the one or more memory devices are further configured to store instructions thereon that, when executed by the one or more processors, cause the one or more processors to:
generate a graphical user interface for display on a user interface, wherein the graphical user interface
prompts a user to capture the image information,
confirms the authenticate code is generated, and
prompt the user to capture the video information and operate the motor.

19. A system comprising:
a shredder including an opening sized to receive an electronic memory device, a platform positioned adjacent the opening and sized to hold the electronic memory device, a motor, and a cutter driven by the motor;
a camera positioned above the platform; and
one or more processing circuits comprising one or more memory devices coupled to one or more processors, the one or more memory devices configured to store instructions thereon that, when executed by the one or more processors, cause the one or more processors to:
receive image information from the camera via a receiving circuit;
identify a visual identifier image within the image information via an object detection circuit;
extract a unique identifier from the visual identifier image via an extraction circuit;
authenticate the unique identifier via an authentication circuit;
receive video information from the camera in response to authenticating the unique identifier;
allow operation of the motor in response to authenticating the unique identifier; and
save the image information, the video information, and the unique identifier to a database.

20. The system of claim 19, wherein the one or more memory devices are further configured to store instructions thereon that, when executed by the one or more processors, cause the one or more processors to:
generate a graphical user interface for display on a user interface, wherein the graphical user interface
prompts a user to capture the image information,
displays that the unique identifier is authenticated, and
prompt the user to capture the video information and operate the motor.
